(19) United States
(12) Patent Application Publication
(10) Pub. No.: US 2013/0003178 A1
(43) Pub. Date: Jan. 3, 2013

(54) THREE-DIMENSIONAL CIRCULAR POLARIZATION EYEGLASSES

(75) Inventor: Pavel Ivan Lazarev, Menlo Park, CA (US)

(73) Assignee: Crysoptix KK, Tokyo (JP)

(21) Appl. No.: 13/538,849

(22) Filed: Jun. 29, 2012

Related U.S. Application Data
(60) Provisional application No. 61/503,140, filed on Jun. 30, 2011.

(51) Int. Cl. G02B 1/08; G02B 27/26

(52) U.S. Cl. 359/465

(57) ABSTRACT

The present invention relates generally to the field of organic chemistry and particularly to the circular polarization eyeglasses intended for viewing the image in 3D-TV and 3D-cinema.

### FIELD OF THE INVENTION

The present invention relates generally to the field of organic chemistry and particularly to the circular polarization eyeglasses intended for viewing the image in 3D-TV and 3D-cinema.

### BACKGROUND OF THE INVENTION

Methods for 3D stereoscopic projection include Anaglyph, Linear Polarization, Circular Polarization, and other technologies. Anaglyph is the oldest technology and provides left/right eye separation by filtering the light through a two color filter, commonly red for one eye, and cyan for the other eye. At the projector, the left eye image is usually filtered through a red filter, and the right image is filtered through a cyan filter. The 3D-eyeglasses consist of a red filter for the left eye, and a cyan filter for the right eye. This method works best for black and white original images, and is not well suited for color images.

In order to present a stereoscopic motion picture using 3D Linear Polarization technology, two superimposed images are projected onto the same screen through orthogonal linear polarizing filters so that filtering of the image intended for the left eye is carried out through a linear polarizer oriented vertically, and filtering of the image intended for the right eye is carried out through a linear polarizer oriented horizontally. The viewer wears 3D-eyeglasses which also contain a pair of orthogonal linear polarizing filters. The 3D-eyeglasses consist of a vertically oriented linear polarizer for the left eye and a horizontally oriented polarizer for the right eye. As each 3D-eyeglasses filter passes only light polarized in parallel and blocks the orthogonally polarized light, each eye sees one of the images only, and the stereoscopic effect is achieved. It is best to use a “silver screen” so that polarization is preserved. This screen is named as the “silver screen” because of its distinctive color. 3D Linear Polarization technology allows a full color image to be displayed with little color distortion. It has several problems, one of which is that the viewer must keep his head oriented vertically to avoid cross-talk interference of the images from one eye to another.

3D Circular Polarization technology was invented to remove the problem of requiring the viewer to keep his head oriented vertically. To present a stereoscopic motion picture using 3D Circular Polarization technology, two superimposed images are projected onto the same screen through orthogonal circular polarizing filters so that filtering of the image intended for the left eye is carried out through a clockwise circular polarizer, and filtering of the image intended for the right eye is carried out through a counter-clockwise circular polarizer. The viewer wears 3D-eyeglasses which also contain a pair of orthogonal circular polarizing filters. The 3D-eyeglasses consist of a clockwise circular polarizer for the left eye and a counter-clockwise circular polarizer for the right eye. As each 3D-eyeglasses filter only passes light which is similarly polarized and blocks the orthogonally polarized light, each eye only sees one of the images, and the stereoscopic effect is achieved. The result is similar to that of stereoscopic viewing using linearly polarized glasses, except the viewer can tilt his head and still maintain left/right separation. A “silver screen” is also needed for this technology.

Lower manufacturing costs mean that the eyeglasses will be more attractively to consumers so reduction of costs of 3D-eyeglasses manufacturing is one of the main tasks of manufacturers. The present invention solves a problem of the further reduction of manufacturing costs of 3D Circular Polarization eyeglasses due to use of new organic materials and simplification of technology.

### SUMMARY OF THE INVENTION

The present invention provides eyeglasses comprising a pair of orthogonal circular polarizing filters. The circular polarizing filter comprises a linear polarizer and a retardation layer located on the surface of the linear polarizer. The retardation layer comprises at least one organic compound of a first type, and/or at least one organic compound of a second type. The organic compound of the first type has the general structural formula I

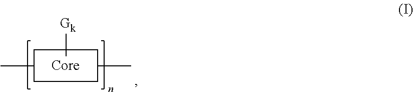

where Core is a conjugated organic unit capable to form a rigid-core macromolecule, n is a number of the conjugated organic units in the rigid-core macromolecule, Gk is a set of ionogenic side-groups; and k is a number of the side-groups in the set Gk. The ionogenic side-groups and the number k provide solubility of the organic compound of the first type in a solvent and give rigidity to the rod-like macromolecule; the number n provides molecule anisotropy that promotes self-assembling of macromolecules in a solution of the organic compound or its salt. The number k is equal to 0, 1, 2, 3, 4, 5, 6, 7, or 8, and the number n is an integer in the range from 10 to 10000. The organic compound of the second type has a general structural formula II

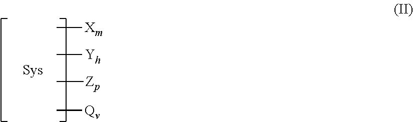

where Sys is an at least partially conjugated substantially planar polycyclic molecular system; X, Y, Z, Q and R are substituents; the substituent X is a carboxylic group —COOH, m is 0, 1, 2, 3 or 4; the substituent Y is a sulfonic group —SO₃H, h is 0, 1, 2, 3 or 4; the substituent Z is a carboxamide —CONH₂, p is 0, 1, 2, 3 or 4; the substituent Q is a sulfonamide —SO₂NH₂, v is 0, 1, 2, 3 or 4. The organic compound of the second type is capable of forming board-like supramolecules via π-π-interaction, and the solid optical retardation layer is substantially transparent to electromagnetic radiation in the visible spectral range. The retardation layer of one circular polarizing filter possesses an in-plane retardation equal to λ₀/4 and the retardation layer of another circular polarizing filter possesses an in-plane retardation equal to 3λ₀/4, where λ₀ is a target wavelength in the visible wavelength range.

### BRIEF DESCRIPTION OF THE DRAWING

FIG. 1 schematically shows eyeglasses according to the present invention

### DETAILED DESCRIPTION OF THE INVENTION

The general description of the present invention having been made, a further understanding can be obtained by reference to the specific preferred embodiments, which are given herein only for the purpose of illustration and are not intended to limit the scope of the appended claims.

Definitions of various terms used in the description and claims of the present invention are listed below.

The term “visible spectral range” refers to a spectral range having the lower boundary approximately equal to 400 nm, and upper boundary approximately equal to 700 nm.

The term “retardation layer” refers to an optically anisotropic layer which is characterized by three principal refractive indices (nₓ, n_{y} and n_{z}), wherein two principal directions for refractive indices nₓ and n_{y} belong to xy-plane coinciding with a plane of the retardation layer and one principal direction for refractive index (n_{z}) coincides with a normal line to the retardation layer.

The term “optically anisotropic biaxial retardation layer” refers to an optical layer which refractive indices nₓ, n_{y}, and n_{z} obey the following condition in the visible spectral range: nₓ≠n_{z}≠n_{y}.

The term “optically anisotropic retardation layer of B_{A}-type” refers to an optical layer which refractive indices nₓ, n_{y}, and n_{z} obey the following condition in the visible spectral range: nₓ<n_{z}<n_{y}.

The term “optically anisotropic retardation layer of A_{C}-type” refers to an optical layer which refractive indices nₓ, n_{y}, and n_{z} obey the following condition in the visible spectral range: n_{z}<n_{y}<nₓ.

The term “optically anisotropic retardation layer of positive A-type” refers to an uniaxial optic layer which principal refractive indices nₓ, n_{y}, and n_{z} obey the following condition in the visible spectral range: n_{z}=n_{y}<nₓ.

The term “optically anisotropic retardation layer of negative A-type” refers to an uniaxial optic layer which principal refractive indices nₓ, n_{y}, and n_{z} obey the following condition in the visible spectral range: n_{z}=n_{y}>nₓ.

The term “NZ-factor” refers to the quantitative measure of degree of biaxiality which is calculated as follows:

$$NZ = \frac{Max ( {n}_{x} , {n}_{y} ) - {n}_{z}}{Max ( {n}_{x} , {n}_{y} ) - Min ( {n}_{x} , {n}_{y} )}$$

The above mentioned definitions are invariant to rotation of system of coordinates (of the laboratory frame) around of the vertical z-axis for all types of anisotropic layers.

The present invention provides the eyeglasses as disclosed hereinabove. In one embodiment of the disclosed eyeglasses, the type and degree of biaxiality of the said optical retardation layer is controlled by a molar ratio of the organic compounds of the first and the second type in the composition. In another embodiment of the disclosed eyeglasses, the type of retardation of said optical retardation layer is selected from the list comprising B_{A}-plate, positive A-plate, A_{C}-plate and negative A-plate. In yet another embodiment of the disclosed eyeglasses, the central wavelength λ₀ is equal to 500 nm. In still another embodiment of the disclosed eyeglasses, the central wavelength λ₀ is equal to 550 nm. In one embodiment of the disclosed eyeglasses, the rigid-core rod-like macromolecule has a polymeric main rigid-chain, and wherein the conjugated organic units are the same. In another embodiment of the disclosed eyeglasses, the rigid-core rod-like macromolecule has a copolymeric main rigid-chain, and wherein at least one conjugated organic unit is different from others. In yet another embodiment of the disclosed eyeglasses, at least one conjugated organic unit (Core) has the general structural formula III

-(Core1)-S1-(Core2)-S2- (III)

wherein Core1 and Core2 are conjugated organic components, and spacers S1 and S2 are selected from the list comprising —CO—NH—, —NH—CO—, —O—NH—, linear and branched (C₁-C₄)alkylenes, linear and branched (C₁-C₄)alkenylenes, —O—CH₂—, —CH₂—O—, —CH═CH—, —CH═CH—COO—, —OOC—CH═CH—, —CO—CH₂—, —OCO—O—, —OCO—, —C≡C—, —CO—S—, —S—, —S—CO—, —O—, —NH—, —N(CH₃)—, in such manner that oxygen atoms are not linked directly to one another. In still another embodiment of the disclosed eyeglasses, at least one rigid-core macromolecule is copolymer having the general structural formula IV

[-(Core1)-S1-(Core2)-S2-]ₙ₋ₜ[-(Core3)-S3-[(Core4)-s4-]ⱼ]ₜ (IV)

wherein Core1, Core2, Core3 and Core4 are conjugated organic components, spacers S1, S2, S3 and S4 are selected from the list comprising —CO—NH—, —NH—CO—, —O—NH—, linear and branched (C₁-C₄)alkylenes, linear and branched (C₁-C₄)alkenylenes, (C₂-C₂₀)polyethylene glycols, —O—CH₂—, —CH₂—O—, —CH═CH—, —CH═CH—COO—, —OOC—CH═CH—, —CO—CH₂—, —OCO—O—, —OCO—, —C≡C—, —CO—S—, —S—, —S—CO—, —O—, —NH—, —N(CH₃)—, in such manner that oxygen atoms are not linked directly to one another, n is an integer in the range from 10 to 10000, t is an integer in the range from 1 to n−1 and j is 0 or 1, and at list one conjugated organic component out of Core3 and Core4 differs from Core1 and Core2. In one embodiment of the disclosed eyeglasses, the conjugated organic components Core1 and Core2 in structural formula III and the conjugated organic components Core1, Core2, Core3 and Core4 in structural formula IV comprising ionogenic groups G are selected from the structures having general formula 1 to 2 shown in Table 1.

TABLE 1
Structural formulas of the conjugated organic components Core1, Core2,
Core3 and Core4 according to the present invention

| | |
|---|---|
| 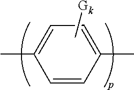 | (1) |
| 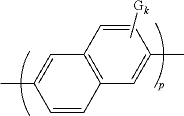 | (2) |

wherein the ionogenic side-groups G are selected from the list comprising —COOH, —SO₃H, and —H₂PO₃, k is equal 0, 1 or 2, p is equal to 1, 2 or 3. In another embodiment of the disclosed eyeglasses, the organic compound of the first type is selected from structures 3 to 13 shown in Table 2, wherein the ionogenic side-group G is sulfonic group —SO₃H, and k is equal to 0, 1 or 2.

TABLE 2
Structural formulas of the organic compound of the first type according to the present invention

| | |
|---|---|
| 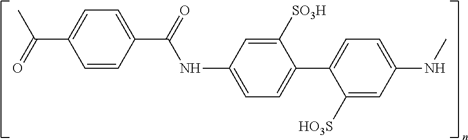 poly(2,2′-disulfo-4,4′-benzidine terephthalamide) | (3) |
| 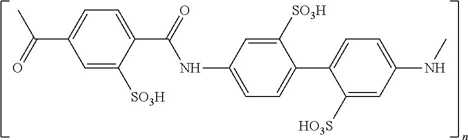 poly(2,2′-disulfo-4,4′-benzidine sulfoterephthalamide) | (4) |
| 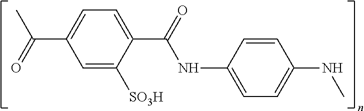 poly(para-phenylene sulfoterephthalamide) | (5) |
| 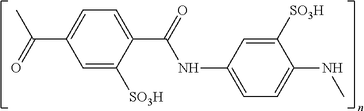 poly(2-sulfo-1,4-phenylene sulfoterephthalamide) | (6) |
| 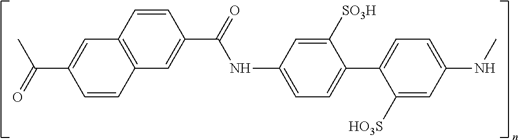 poly(2,2′-disulfo-4,4′-benzidine naphthalene-2,6-dicarboxamide) | (7) |
| 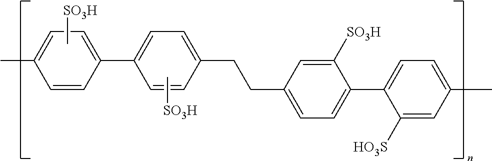 Poly(disulfobiphenylene-1,2-ethylene-2,2′-disulfobiphenylene) | (8) |
| 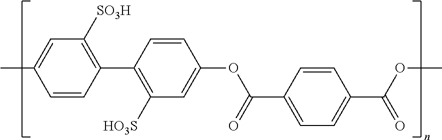 Poly(2,2′-disulfobiphenyl-dioxyterephthaloyl) | (9) |
| 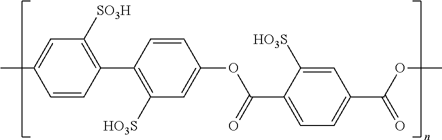 Poly(2,2′-disulfobiphenyl-2-sulfodioxyterephthaloyl) | (10) |
| 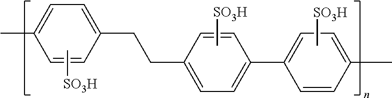 Poly(sulfophenylene-1,2-ethylene-2,2′-disulfobiphenylene) | (11) |
| 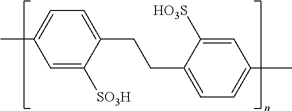 Poly(2-sulfophenylene-1,2-ethylene-2′-sulfophenylene) | (12) |
| 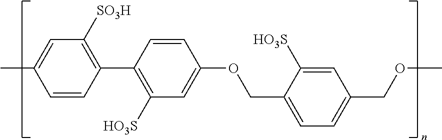 Poly(2,2′-disulfobiphenyl-2-sulfo-1,4-dioxymethylphenylene) | (13) |

In yet another embodiment of the disclosed eyeglasses, the organic compound of the first type further comprises additional side-groups independently selected from the list comprising linear and branched (C₁-C₂₀)alkyl, (C₂-C₂₀)alkenyl, and (C₂-C₂₀)alkinyl. In still another embodiment of the disclosed eyeglasses, the at least one of the additional side-groups is connected with the Core via a bridging group A selected from the list comprising —C(O)—, —C(O)O—, —C(O)—NH—, —(SO₂)NH—, —O—, —CH₂O—, —NH—, >N—, and any combination thereof. In one embodiment of the disclosed eyeglasses, the salt of the organic compound of the first type is selected from the list comprising ammonium and alkali-metal salts. In another embodiment of the disclosed eyeglasses, the organic compound of the second type has at least partially conjugated substantially planar polycyclic molecular system Sys selected from the structures of general formulas 14 to 28 shown in Table 3.

TABLE 3
Structural formulas of substantially planar polycyclic molecular system Sys of the
organic compound of the second type according to the present invention

| | |
|---|---|
| 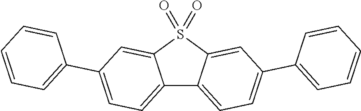 [SMILES: O=S1(=O)c2cc(-c3ccccc3)ccc2-c2ccc(-c3ccccc3)cc21] | (14) |
| 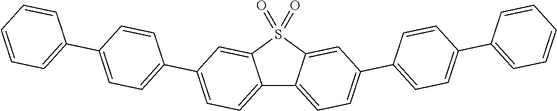 [SMILES: O=S1(=O)c2cc(-c3ccc(-c4ccccc4)cc3)ccc2-c2ccc(-c3ccc(-c4ccccc4)cc3)cc21] | (15) |
| 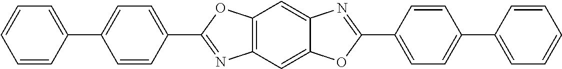 [SMILES: c1ccc(-c2ccc(-c3nc4cc5oc(-c6ccc(-c7ccccc7)cc6)nc5cc4o3)cc2)cc1] | (16) |
| 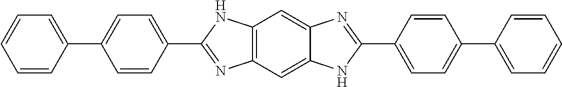 [SMILES: c1ccc(-c2ccc(-c3nc4cc5[nH]c(-c6ccc(-c7ccccc7)cc6)nc5cc4[nH]3)cc2)cc1] | (17) |
| 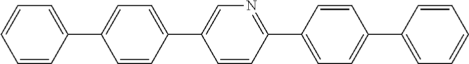 [SMILES: c1ccc(-c2ccc(-c3ccc(-c4ccc(-c5ccccc5)cc4)nc3)cc2)cc1] | (18) |
| 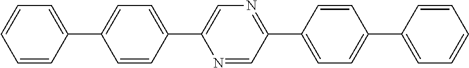 [SMILES: c1ccc(-c2ccc(-c3cnc(-c4ccc(-c5ccccc5)cc4)cn3)cc2)cc1] | (19) |
| 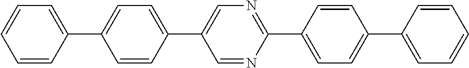 [SMILES: c1ccc(-c2ccc(-c3cnc(-c4ccc(-c5ccccc5)cc4)nc3)cc2)cc1] | (20) |
| 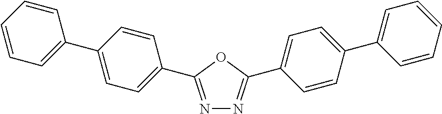 [SMILES: c1ccc(-c2ccc(-c3nnc(-c4ccc(-c5ccccc5)cc4)o3)cc2)cc1] | (21) |
| 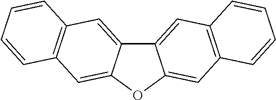 [SMILES: c1ccc2cc3c(cc2c1)oc1cc2ccccc2cc13] | (22) |
| 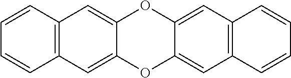 [SMILES: c1ccc2cc3c(cc2c1)Oc1cc2ccccc2cc1O3] | (23) |
| 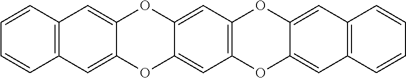 [SMILES: c1ccc2cc3oc4cc5oc6cc7ccccc7cc6oc5cc4oc3cc2c1] | (24) |
| 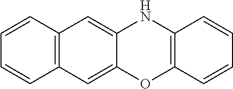 [SMILES: c1ccc2c(c1)Nc1cc3ccccc3cc1O2] | (25) |
| 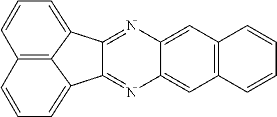 [SMILES: c1ccc2cc3nc4c(nc3cc2c1)-c1cccc2cccc-4c12] | (26) |
| 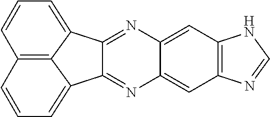 [SMILES: c1cc2c3c(cccc3c1)-c1nc3cc4[nH]cnc4cc3nc1-2] | (27) |
| 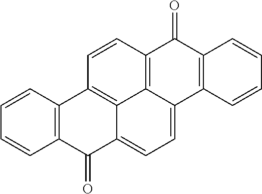 [SMILES: O=C1c2ccccc2-c2ccc3c4c(ccc1c24)-c1ccccc1C3=O] | (28) |

In one embodiment of the disclosed eyeglasses, the organic compound of the second type is selected from structures 29 to 37 shown in Table 4, where the molecular system Sys is selected from the structures 14 and 22 to 28, the substituent is a sulfonic group —SO₃H, and m, p, v, and w are equal to 0.

TABLE 4
Structural formulas of the organic compound of the second type according to the present invention

| | |
|---|---|
| 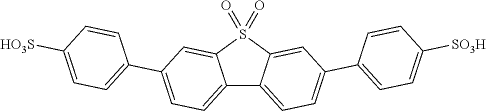 [SMILES: O=S(=O)(O)c1ccc(-c2ccc3c(c2)S(=O)(=O)c2cc(-c4ccc(S(=O)(=O)O)cc4)ccc2-3)cc1] 4,4′-(5,5-dioxidodibenzo[b,d]thiene-3,7-diyl)dibenzenesulfonic acid | (29) |
| 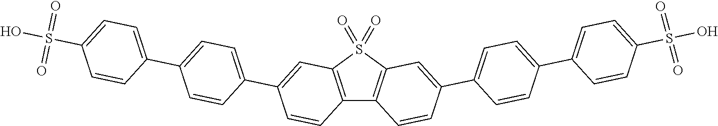 [SMILES: O=S(=O)(O)c1ccc(-c2ccc(-c3ccc4c(c3)S(=O)(=O)c3cc(-c5ccc(-c6ccc(S(=O)(=O)O)cc6)cc5)ccc3-4)cc2)cc1] 4′,4″-(5,5-dioxidodibenzo[b,d]thiene-3,7-diyl)dibiphenyl-4- sulfonic acid (p-sexiphenyl disulfosulfone) | (30) |
| 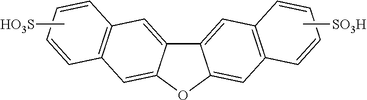 dinaphto[2,3-b:2′,3′-d]furan disulfonic acid | (31) |
| 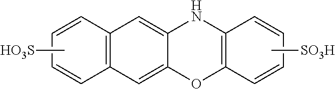 12H-benzo[b]phenoxazine disulfonic acid | (32) |
| 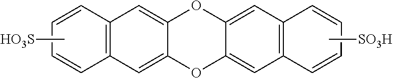 dibenzo[b,i]oxanthrene disulfonic acid | (33) |
| 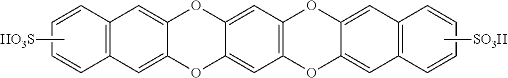 benzo[b]naphto[2′,3′:5,6]dioxino[2,3-i]oxanthrene disulfonic acid | (34) |
| 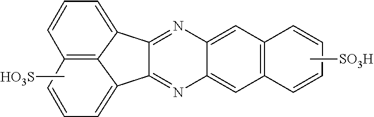 acenaphtho[1,2-b]benzo[g]quinoxaline disulfonic acid | (35) |
| 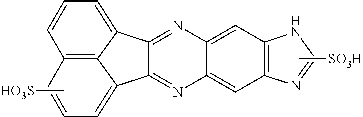 9H-acenaphtho[1,2-b]imidazo[4,5-g]quinoxaline disulfonic acid | (36) |
| 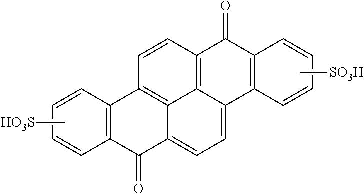 dibenzo[b,def]chrysene-7,14-dion disulfonic acid | (37) |

In one embodiment of the present invention, the disclosed eyeglasses further comprises inorganic compounds which are selected from the list comprising hydroxides and salts of alkali metals. In yet another embodiment of the disclosed eyeglasses, the linear polarizer is made on substrate of a birefringent material, which is selected from the list comprising polyethylene terephtalate (PET), polyethylene naphtalate (PEN), polyvinyl chloride (PVC), polycarbonate (PC), polypropylene (PP), polyethylene (PE), polyimide (PI), and polyester.

In order that the invention may be more readily understood, reference is made to the following examples, which are intended to be illustrative of the invention, but are not intended to be limiting the scope.

### EXAMPLES

### Example 1

This Example describes synthesis of poly(2,2′-disulfo-4,4′-benzidine terephthalamide) cesium salt (structure 3 in Table 2).

1.377 g (0.004 mol) of 4,4′-diaminobiphenyl-2,2′-disulfonic acid was mixed with 1.2 g (0.008 mol) of Cesium hydroxide and 40 ml of water and stirred with dispersing stirrer till dissolution. 0.672 g (0.008 mol) of sodium bicarbonate was added to the solution and stirred. While stirring the obtained solution at high speed (2500 rpm) the solution of 0.812 g (0.004 mol) of terephthaloyl dichloride in dried toluene (15 mL) was gradually added within 5 minutes. The stirring was continued for 5 more minutes, and viscous white emulsion was formed. Then the emulsion was diluted with 40 ml of water, and the stirring speed was reduced to 100 rpm. After the reaction mass has been homogenized the polymer was precipitated via adding 250 ml of acetone. Fibrous sediment was filtered and dried.

Gel permeation chromatography (GPC) analysis of the sample was performed with Hewlett Packard 1050 chromatograph with diode array detector (λ=230 nm), using Varian GPC software Cirrus 3.2 and TOSOH Bioscience TSKgel G5000 PW_{XL} column and 0.2 M phosphate buffer (pH=7) as the mobile phase. Poly(para-styrenesulfonic acid) sodium salt was used as GPC standard. The number average molecular weight Mn, weight average molecular weight Mw, and polydispersity P were found as 3.9×10⁵, 1.7×10⁶, and 4.4 respectively.

### Example 2

This Example describes synthesis of poly(2,2′-disulfo-4,4′-benzidine sulfoterephthalamide) (structure 4 in Table 2).

10 g (40 mmol) of 2-sulfoterephtalic acid, 27.5 g (88.7 mmol) of triphenylphosphine, 20 g of Lithium chloride and 50 ml of pyridine were dissolved in 200 ml of N-methylpyrrolidone in a 500 ml three-necked flask. The mixture was stirred at 40° C. for 15 min and then 13.77 g (40 mmol) of 4,4′-diaminobiphenyl-2,2′-disulfonic acid were added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

### Example 3

This Example describes synthesis of poly(para-phenylene sulfoterephthalamide) (structure 5 in Table 2).

10 g (40 mmol) of 2-sulfoterephtalic acid, 27.5 g (88.7 mmol) of triphenylphosphine, 20 g of Lithium chloride and 50 ml of pyridine were dissolved in 200 ml of N-methylpyrrolidone in a 500 ml three-necked flask. The mixture was stirred at 40° C. for 15 min and then 4.35 g (40 mmol) of 1,4-phenylenediamine were added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

### Example 4

This Example describes synthesis of poly(2-sulfo-1,4-phenylene sulfoterephthalamide) (structure 6 in Table 2).

10 g (40 mmol) of 2-sulfoterephtalic acid, 27.5 g (88.7 mmol) of triphenylphosphine, 20 g of Lithium chloride and 50 ml of pyridine were dissolved in 200 ml of N-methylpyrrolidone in a 500 ml three-necked flask. The mixture was stirred at 40° C. for 15 min and then 7.52 g (40 mmol) of 2-sulfo-1,4-phenylenediamine were added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

### Example 5

This Example describes synthesis of poly(2,2′-disulfo-4,4′-benzidine naphthalene-2,6-dicarboxamide) cesium salt (structure 7 in Table 2).

0.344 g (0.001 mol) of 4,4′-diaminobiphenyl-2,2′-disulfonic acid was mixed with 0.3 g (0.002 mol) of Cesium hydroxide and 10 ml of water and stirred with dispersing stirrer till dissolution. 0.168 g (0.002 mol) of sodium bicarbonate was added to the solution and stirred. While stirring the obtained solution at high speed (2500 rpm) the solution of 0.203 g (0.001 mol) of terephthaloyl dichloride in dried toluene (4 mL) was gradually added within 5 minutes. The stirring was continued for 5 more minutes, and viscous white emulsion was formed. Then the emulsion was diluted with 10 ml of water, and the stirring speed was reduced to 100 rpm. After the reaction mass has been homogenized the polymer was precipitated via adding 60 ml of acetone. The fibrous sediment was filtered and dried. Molecular weight analysis of the sample via GPC was performed as described in Example 1.

### Example 6

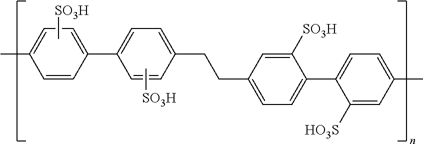

This example describes synthesis of Poly(disulfobiphenylene-1,2-ethylene-2,2′-disulfobiphenylene) (structure 8 in Table 2).

36 g of finely ground bibenzyl in a Petri dish is set on a porcelain rack in a desiccator with an evaporating dish under the rack containing 80 g of bromine. The desiccator is closed but a very small opening is provided for the escape of hydrogen bromide. The bibenzyl is left in contact with the bromine vapors for overnight. Then the dish with bromine is removed from the desiccator and the excess of bromine vapors evacuated by water pump. The orange solid is then recrystallized from 450 ml of isopropyl alcohol. The yield of 4,4′-dibromobibenzyl is 20 g.

To a stirred solution of 3 g of 4,4′-dibromobibenzyl in 100 ml of dry tetrahydrofuran under argon, a 5.4 ml of 2.5 M solution of butyllithium in hexane is added dropwise at −78° C. The mixture is stirred at this temperature 6 hrs to give a white suspension. 6 ml of triisopropylborate is added, and the mixture is stirred overnight allowing the temperature to rise to room temperature. 30 ml of water is added and the mixture stirred at room temperature 4 hrs. The organic solvents are removed on a rotavapor (35° C., 40 mbar), then 110 ml of water is added and the mixture acidified with concentrated HCl. The product is extracted into diethyl ether (7×30 ml), the organic layer dried over magnesium sulfate and the solvent removed on a rotavapor. The residue is dissolved in 11 ml of acetone and reprecipitated into a mixture of 13 ml of water and 7 ml of concentrated hydrochloric acid. The yield of dipropyleneglycol ester of bibenzyl 4,4′-diboronic acid is 2.4 g.

100 g of 4,4′-diamino-2,2′-biphenyldisulfonic acid, 23.2 g of sodium hydroxide and 3500 ml of water are mixed and cooled to 0-5° C. A solution of 41 g of sodium nitrite in 300 ml of water is added, the solution is stirred for 5 min and then 100 ml of 6M hydrochloric acid is added. A pre-cooled solution of 71.4 g of potassium bromide in 300 ml of water is added to the resulting dark yellow solution in 2 ml portions. After all the potassium bromide has been added the solution is allowed to warm up to room temperate. Then the reaction mixture is heated and held at 90° C. for 16 hours. A solution of 70 g of sodium hydroxide in 300 ml of water is added, the solution evaporated to a total volume of 400 ml, diluted with 2500 ml of methanol to precipitate the inorganic salts and filtered. The methanol is evaporated to 20-30 ml and 3000 ml of isopropanol is added. The precipitate is washed with methanol on the filter and recrystallized from methanol. Yield of 4,4′-dibromo-2,2′-biphenyldisulfonic acid is 10.7 g.

The polymerization is carried out under nitrogen. 2.7 g of 4,4′-dihydroxy-2,2′-biphenyldisulfonic acid and 2.0 g of dipropyleneglycol ester of bibenzyl 4,4′-diboronic acid are dissolved in a mixture of 2.8 g of sodium hydrocarbonate, 28.5 ml of tetrahydrofuran and 17 ml of water. Tetrakis(triphenylphosphine)palladium(0) is added (5×10⁻³ molar equivalent compared to dipropyleneglycol ester of bibenzyl 4,4′-diboronic acid). The resulting suspension is stirred 20 hrs. 0.04 g of bromobenzene is then added. After an additional 2 hrs the polymer is precipitated by pouring it into 150 ml of ethanol. The product is washed with water, dried, and dissolved in toluene. The filtered solution is concentrated and the polymer precipitated in a 5-fold excess of ethanol and dried. The yield of polymer is 2.7 g.

8.8 g of 95% sulfuric acid is heated to 110° C. and 2.7 g of the polymer is added. The temperature is raised to 140° C. and held for 4 hours. After cooling down to 100° C. 8 ml of water is added dropwise and the mixture is allowed to cool. The resulting suspension is filtered, washed with conc. hydrochloric acid and dried. Yield of the sulfonated polymer is ˜2 g.

### Example 7

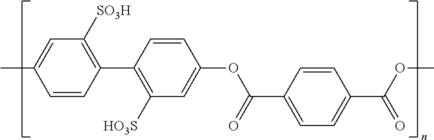

This example describes synthesis of Poly(2,2′-disulfobiphenyl-dioxyterephthaloyl) (structure 9 in Table 2).

1.384 g (0.004 mol) of 4,4′-dihydroxybiphenyl-2,2′-disulfonic acid was mixed with 2.61 g (0.008 mol) of sodium carbonate and 40 ml of water in 500 ml beaker and stirred with dispersing stirrer until the solid completely dissolved. Dichloromethane (50 ml) was added to the solution. Upon stirring at high speed (7000 rpm) the solution of 0.812 g (0.004 mol) of terephthaloyl chloride in anhydrous dichloromethane (15 ml) was added. Stirring was continued for 30 minutes, and 400 ml of acetone were added to the thickened reaction mass. Solid polymer was crushed with the stirrer and separated by filtration. The product was washed three times with 80% ethanol and dried at 50° C.

### Example 8

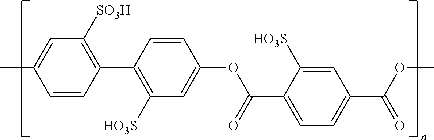

This example describes synthesis of Poly(2,2′-disulfobiphenyl-2-sulfodioxyterephthaloyl) (structure 10 in Table 2).

1.384 g (0.004 mol) of 4,4′-dihydroxybiphenyl-2,2′-disulfonic acid was mixed with 3.26 g (0.010 mol) of sodium carbonate and 40 ml of water in 500 ml beaker and stirred with dispersing stirrer until the solid completely dissolved. Dichloromethane (60 ml) was added to the solution. Upon stirring at high speed (7000 rpm) 1.132 g (0.004 mol) of 2-sulfoterephthaloyl chloride was added within 15 minutes. Stirring was continued for 3 hours, and 400 ml of acetone were added to the thickened reaction mass. Precipitated polymer was separated by filtration and dried at 50° C.

### Example 9

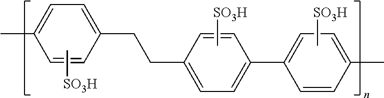

This example describes synthesis of Poly(sulfophenylene-1,2-ethylene-2,2′-disulfobiphenylene) (structure 11 in Table 2).

36 g of finely ground bibenzyl in a Petri dish is set on a porcelain rack in a desiccator with an evaporating dish under the rack containing 80 g of bromine. The desiccator is closed but a very small opening is provided for the escape of hydrogen bromide. The bibenzyl is left in contact with the bromine vapors for overnight. Then the dish with bromine is removed from the desiccator and the excess of bromine vapors evacuated by water pump. The orange solid is then recrystallized from 450 ml of isopropyl alcohol. The yield of 4,4′-dibromobibenzyl is 20 g.

A solution of 23.6 g of 1,4-dibromobenzene in 90 ml of dry tetrahydrofuran is prepared. 10 ml of the solution is added with stirring to 5.0 g of magnesium chips and iodine (a few crystals) in 60 ml of dry tetrahydrofuran and the mixture heated until reaction starts. Boiling conditions are maintained by the gradual addition of the rest of dibromobenzene solution. Then the reaction mixture is boiled for 8 hours and left overnight under argon at room temperature. The mixture is transferred through a hose to a dropping funnel by means of argon pressure and added to a solution of 24 ml of trimethylborate in 40 ml of dry tetrahydrofuran during 3 h at −78-70° C. (solid carbon dioxide/acetone bath) and vigorous stirring. The mixture is stirred for 2 hrs, then allowed to heat to room temperature with stirring overnight under argon. The mixture is diluted with 20 ml of ether and poured to a stirred mixture of crushed ice (200 g) and conc. H₂SO₄ (6 ml). To facilitate separation of the organic and aqueous layers 20 ml of ether and 125 ml of water are added, and the mixture is filtered. The aqueous layer is extracted with ether (4×40 ml), the combined organic extracts are washed with 50 ml of water, dried over Sodium sulfate and evaporated to dryness. The light brown solid is dissolved in 800 ml of chloroform and clarified.

The chloroform solution is evaporated almost to dryness, and the residual solid is recrystallized from benzene. A white slightly yellowish precipitate is filtered off and dried. The yield of dipropyleneglycol ester of benzyne 1,4-diboronic acid is 0.74 g.

The polymerization is carried out under nitrogen. 2.7 g of 4,4′-dibromo-2,2′-bibenzyl and 1.9 g of dipropyleneglycol ester of benzyne 1,4-diboronic acid are added to in a mixture of 2.8 g of sodium hydrocarbonate, 28.5 ml of tetrahydrofuran and 17 ml of water. Tetrakis(triphenylphosphine)palladium(0) is added (5×10⁻³ molar equivalent compared to dipropyleneglycol ester of benzyne 1,4-diboronic acid). The resulting suspension is stirred for 20 hrs. 0.04 g of bromobenzene is then added. After an additional 2 hrs the polymer is precipitated by pouring it into 150 ml of ethanol. The product is washed with water, dried, and dissolved in toluene. The filtered solution is concentrated, and the polymer was precipitated in a 5-fold excess of ethanol and dried. The yield of polymer is 2.5 g.

8.8 g of 95% sulfuric acid is heated to 110° C., and 2.7 g of the polymer is added. The temperature is raised to 140° C. and held for 4 hours. After cooling down to the room temperature 8 ml of water is added dropwise, and the mixture is allowed to cool. The resulting suspension is filtered, washed with conc. hydrochloric acid and dried. Yield of the sulfonated polymer is 1.5 g.

### Example 10

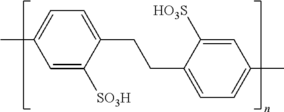

This example describes synthesis of Poly(2-sulfophenylene-1,2-ethylene-2′-sulfophenylene) (structure 12 in Table 2).

The polymerization is carried out under nitrogen. 10.2 g of 2,2′-[ethane-1,2-diylbis(4,1-phenylene)]bis-1,3,2-dioxaborinane, 10.5 g of 1,1′-ethane-1,2-diylbis(4-bromobenzene) and 1 g of tetrakis(triphenylphosphine)palladium(0) are mixed under nitrogen. Mixture of 50 ml of 2.4 M solution of potassium carbonate and 300 ml of tetrahydrofuran is degassed by nitrogen bubbling. Obtained solution is added to the first mixture. After that the reaction mixture is agitated at ˜40° C. for 72 hours. The polymer is precipitated by pouring it into 150 ml of ethanol. The product is washed with water and dried. The yield of polymer is 8.7 g.

8.5 g of polymer is charged into 45 ml of 95% sulfuric acid. Reaction mass is agitated at ˜140° C. for 4 hours. After cooling down to the room temperature 74 ml of water is added dropwise, and the mixture is allowed to cool. The resulting suspension is filtered, washed with conc. hydrochloric acid and dried. Yield of the sulfonated polymer is 8 g.

### Example 11

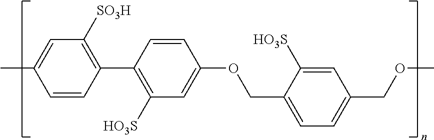

This example describes synthesis of Poly (2,2′-disulfobiphenyl-2-sulfo-1,4-dioxymethylphenylene) (structure 13 in Table 2).

190 g of 4,4′-diaminobiphenyl-2,2′-disulfonic acid and 41.5 g of sodium hydroxide are dissolved in 1300 ml of water. 1180 g of ice is charged to this solution with stirring. Then 70.3 g of sodium nitrite, 230.0 ml of sulfuric acid and 1180 ml of water are added to the reaction mass and stirred for 1 hr at −2-0° C. Then the mixture is filtered and washed with 2400 ml of icy water. The filter cake is suspended in 800 ml of water and heated to 100° C. Then water is distilled out until about ˜600 ml of solution remained. 166 g of cesium hydroxide hydrate in 110 ml of water is added to the solution. Then it is added to 6000 ml of ethanol, the resulting suspension is stirred at room temperature, filtered, and the filter cake washed with 600 ml of ethanol and dried in vacuum oven at 45° C. The yield of 4,4′-dihydroxybiphenyl-2,2′-disulfonic acid is 230 g.

30 ml of 96% sulfuric acid and 21 g of p-xylene are mixed, heated to 100° C. and kept at temperature for 15 min. The reaction mass is cooled to room temperature, quenched with 50 g water and ice. The resulting suspension is cooled to −10° C., filtered, and the obtained filter cake washed with cold hydrochloric acid (15 ml of conc. acid and 10 ml of water). The precipitate is squeezed and recrystallized from hydrochloric acid solution (40 ml of conc. acid and 25 ml of water). The white substance is dried under vacuum at 90° C. The yield of p-xylene sulfonic acid is 34 g.

A mixture of 35 ml of carbon tetrachloride, 2.5 g of p-xylene sulfonic acid, 4.8 g of N-bromosuccinimide and 0.16 g of benzoyl peroxide is heated with agitation to boiling and held at temperature 60 min. Then additional 0.16 g of benzoyl peroxide is added, and the mixture is kept boiling for additional 60 min. After cooling the product is extracted with 45 ml of water and recrystallized form 20% hydrochloric acid. The yield of 2,5-bis(bromomethyl)benzene sulfonic acid is approximately 1 g.

To a 25-ml flask equipped with a condenser and nitrogen inlet-outlet are successively added 0.23 g of 4,4′-dihydroxybiphenyl-2,2′-disulfonic acid, 1.2 ml of o-dichlorobenzene, 0.22 g of 2,5-bis(bromomethyl)benzene sulfonic acid, 1.2 ml of 10N sodium hydroxide, and 0.081 g of tetrabutylammonium hydrogen sulfate. The reaction mixture is stirred at 80° C. under nitrogen. After 6 hrs of reaction the organic layer is isolated and washed with water, followed by dilute hydrochloric acid, and again with water. Then the solution is added to methanol to precipitate white polymer. The polymer is then reprecipitated from acetone and methanol.

### Example 12

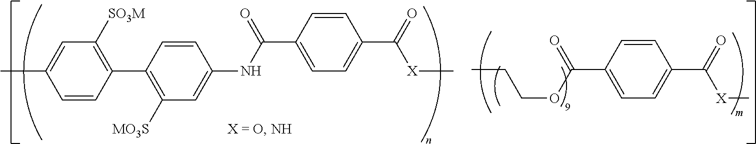

This example describes synthesis of copolymer of 2,2′-disulfo-4,4′-benzidine terephthaloylchloride and polyethylene glycol 400 (structure 3 in Table 2 added with chains of polyethylene glycols, where M is hydrogen). 4,4′-diaminobiphenyl-2,2′-disulfonic acid (4.1 g) was mixed with of cesium hydroxide hydrate (4.02 g, 2.0 equiv) in water (150 ml) in a 1 L beaker and stirred until the solid completely dissolved. Cesium bicarbonate (3.9 g, 1.0 equiv) dissolved in 10 ml of water was added to this solution and stirred with a electric mixer at room temperature during 1 min. Chloroform (40 ml) and polyethylene glycol 400 (8.0 g) were added. Upon stirring at high speed a solution of terephthaloylchloride (2.42 g, 1.0 equiv) in 10 ml of chloroform was added in one portion pouring from the beaker. The reaction was left without stirring at ambient conditions for 30 minutes. 300 ml of ethanol was added, thickened reaction mass was crushed with the stirrer, and polymer was filtered. The product was suspended in 200 ml of 80% ethanol, stirred for 15 min and filtered. Washing with ethanol was repeated one more time. The product was washed with 200 ml of acetone in a similar way. Solid copolymer was dried at 85° C. for 14 hrs.

The introduction of ethylene oxide fragment into rigid-core polymer allows modification of macromolecule elasticity, which in its turn improves phases' coexistence in guest-host mixture.

### Example 12

This Example describes synthesis of 4,4′-(5,5-dioxidodibenzo[b,d]thiene-3,7-diyl)dibenzenesulfonic acid (structure 29 in Table 4).

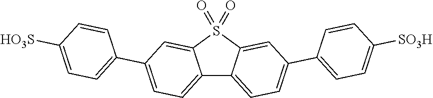 [SMILES: O=S(=O)(O)c1ccc(-c2ccc3c(c2)S(=O)(=O)c2cc(-c4ccc(S(=O)(=O)O)cc4)ccc2-3)cc1]

1,1′:4′,1″:4″,1′″-quarerphenyl (10 g) was charged into 0%-20% oleum (100 ml). Reaction mass was agitated for 5 hours at heating to 50° C. After that the reaction mixture was diluted with water (170 ml). The final sulfuric acid concentration became approximately 55%. The precipitate was filtered and rinsed with glacial acetic acid (˜200 ml). The filter cake was dried in an oven at 110° C.

HPLC analysis of the sample was performed with Hewlett Packard 1050 chromatograph with diode array detector (λ=310 nm), using Reprosil™ Gold C8 column and linear gradient elution with acetonitrile/0.4 M ammonium acetate (pH=3.5 acetic acid) aqueous solution.

### Example 13

This Example describes synthesis of 4′,4″-(5,5-dioxidodibenzo[b,d]thiene-3,7-diyl)dibiphenyl-4-sulfonic acid (p-sexiphenyl disulfosulfone) (structure 30 in Table 4).

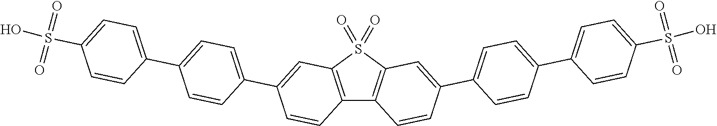 [SMILES: O=S(=O)(O)c1ccc(-c2ccc(-c3ccc4c(c3)S(=O)(=O)c3cc(-c5ccc(-c6ccc(S(=O)(=O)O)cc6)cc5)ccc3-4)cc2)cc1]

100 g of dibenzo[b,d]thiophene is agitated with 1000 ml of glacial acetic acid and 175 ml of 30% hydrogen peroxide at 100° C. for 1 hour. Then the reaction mass is cooled down to room temperature, the precipitated matter is isolated by filtration, and the filter cake rinsed with 5 L of water and squeezed. The obtained dibenzo[b,d]thiophene-5,5-dioxide is dried at 80° C. Yield is 108 g.

108 g of dibenzo[b,d]thyophene-5,5-dioxide is mixed with 690 ml of bromine and 7.1 g of powdered iron at 20-25° C. The mixture is heated to 56-58° C. and held at temperature for 60 min. 460 ml of water is added, and bromine is evaporated. 4.5 L of water and 300 g of sodium metabisulfite are added to the residuum of the reaction mass, the resulting mass heated up to 80° C. and held at temperature for 60 min. The suspension is filtered, the filter cake rinsed with 3 L of water, then with 3 L of 50% acetic acid and squeezed. The obtained material is dried at 90° C. Yield of raw 3,7-dibromodibenzo[b,d]thiophene-5,5-dioxide is 176 g.

The raw substance is dissolved in 1800 ml of 1,4-dioxane at 100° C. 300 ml of water is added, and the mixture cooled down to room temperature. The precipitated matter is isolated by filtration and rinsed with 3 L of water. The obtained material is dried at 90° C. 146 g of 3,7-dibromodibenzo[b,d]thiophene-5,5-dioxide is obtained. 146 g of 3,7-dibromodibenzo[b,d]thiophene-5,5-dioxide is dissolved in 4 L of N-methylpyrrolidone (NMP). Solution of 134 g of sodium carbonate in 800 ml of water is added. 8.8 g of 10% Pd/C catalyst and 240 g of 4-biphenylboronic acid are added under Ar blanket. The reaction flask is heated to 100° C. and held at temperature 4 hrs. 500 ml of water is added to the hot reaction mixture and after cooling to room temperature it is filtered. The filter cake is added to 2.5 L of NMP and heated to 100° C. with agitation. The mixture is filtered, and the filter cake is rinsed with 800 ml of hot NMP. 1100 ml of water is added to the hot filtrate. The precipitated material is isolated and washed with 20 L of water. The obtained material is dried at 90° C. Yield of 3,7-dibiphenyl-4-yldibenzo[b,d]thiophene-5,5-dioxide is 147 g.

147 g of dry ground 3,7-dibiphenyl-4-yldibenzo[b,d]thiophene-5,5-dioxide is mixed with 1900 ml of 95% sulfuric acid and stirred at 20-25° C. for 10 hrs. 700.0 ml of water is gradually added to the reaction and the precipitated solid isolated by filtration, the filter cake rinsed with 1 L of glacial acetic acid and squeezed. The filter cake is washed with 4 L of acetic acid, then with 3 L of toluene and squeezed. The obtained material is dried at 20 mm Hg and 130° C. Yield of dry 4′,4″-(5,5-dioxidodibenzo[b,d]thiene-3,7-diyl)dibiphenyl-4-sulfonic acid (p-sexiphenyl disulfosulfone) is 180 g.

### Example 14

This Example describes preparation of an optical retardation layer of +A-type from a lyotropic liquid crystal solution of poly(2,2′-disulfo-4,4′-benzidine terephthalamide) (structure 3 in Table 2) cesium salt.

Poly(2,2′-disulfo-4,4′-benzidine terephthalamide) was synthesized as described in Example 1. The lyotropic liquid crystal solution was prepared according to the following procedure: 1% water solution was prepared, filtered from mechanical admixtures, and concentrated to approximately 5.6 wt. % via evaporation.

Fisher-brand microscope glass slides were treated with a 10% sodium hydroxide solution for 30 min, followed by rinsing with deionized water and drying in airflow with the aid of a compressor. The solution was applied onto the glass plate surface with a Mayer rod #4 moved at a linear velocity of ˜100 mm/s at room temperature of 23° C. and a relative humidity of 50%. The coated liquid layer of the solution was dried at the same humidity and temperature.

In order to determine the optical characteristics of the retardation layer, the optical transmission and reflection spectra were measured in a wavelength range from approximately 400 to 700 nm using a Cary 500 Scan spectrophotometer. The optical transmission of the solid retardation layer was measured using light beams linearly polarized being parallel and perpendicular to the coating direction (Tₚₐᵣ and Tₚₑᵣ, respectively), propagating in direction perpendicular to the retardation film plane. The optical reflection was measured using S-polarized light propagating at an angle of 12 degree to the normal of the retardation film plane and polarized parallel and perpendicular to the coating direction (Rₚₐᵣ and Rₚₑᵣ, respectively). The phase retardation of the retardation film samples was measured at incident angles of 0, 30, 45 and 60 degrees using Axometrics Mueller Matrix polarimeter. The obtained data were used to calculate the principal refractive indices (nₓ, n_{y}, and n_{z}) of the retardation layer. The obtained retardation layer was characterized as a positive A-plate (nₓ=1.83, n_{y}=1.55, n_{z}=1.55 at the wavelength λ=550 nm).

### Example 15

This Example describes preparation of a solid optical retardation layer of -A-type from a solution of (4,4′-(5,5-dioxidodibenzo[b,d]thiene-3,7-diyl)dibenzenesulfonic acid (structure 29 in Table 4).

4,4′-(5,5-dioxidodibenzo[b,d]thiene-3,7-diyl)dibenzenesulfonic acid (1 g) was obtained as described in Example 12, mixed with 8.5 g of distilled water and 0.5 g of 20% aqueous solution of lithium hydroxide, and then stirred at room temperature (23° C.) for approximately 1 hour until a lyotropic liquid crystal solution was formed.

The coatings were produced and optically characterized as described in Example 14. The obtained solid optical retardation layer was characterized by the principle refractive indices, which obey the following condition: nₓ<n_{z}=n_{y}. NZ-factor at the wavelength λ=550 nm is about 0.

### Example 16

This Example describes preparation of a retardation layer of the A_{C}-type from a solution comprising a binary composition of poly(2,2′-disulfo-4,4′-benzidine sulfoterephthalamide) (structure 4 in Table 2) cesium salt referenced hereafter as P2, and the compound C1 described in Example 12. Said composition of organic compounds is capable of forming a joint lyotropic liquid crystal system. The rigid-core rod-like macromolecules of P2 are capable of aligning together with π-π stacks (columns) of board-like supramolecules C1.

The P2/C1=65/35 mol % composition was prepared as follows: 5.32 g (0.0065 mol) of cesium salt of P2 was dissolved in 475 g of de-ionized water (conductivity ˜5 μm/cm); the suspension was mixed with a magnet stirrer. After dissolving, the solution was filtered with the hydrophilic nylon filter with pore size 45 μm. Separately, 1.86 g (0.0035 mol) of C1 was dissolved in 60 g of de-ionized water; the suspension was mixed with a magnet stirrer. While stirring, 4.4 ml of 20 wt. % Cesium hydroxide (0.007 mol) was gradually added drop-by-drop into suspension for approximately 15 minutes until a clear solution was formed. Clear solutions of P2 and C1 were mixed together to form 547 g of a clear solution. This composition was concentrated on a rotary evaporator in order to remove an excess of water and formed 127 g of a binary composition representing a lyotropic liquid crystal (LLC) solution. The total concentration of the composition (P2+C1) C_{TOT} was equal to about 6 wt. %.

The coatings were produced and optically characterized as described in the Example 14. The obtained data were used to calculate the principal refractive indices (nₓ, n_{y}, and n_{z}) of the retardation layer. The value of NZ-factor of the retardation layer is equal to about 2.0.

### Example 17

This Example describes preparation of a retardation layer of the A_{C}-type from a solution comprising a binary composition of poly(2,2′-disulfo-4,4′-benzidine naphthalene-2,6-dicarboxamide) (structure 7 in Table 2) referenced hereafter as P3, and C1 described in Example 12. Said composition of organic compounds is capable of forming a joint lyotropic liquid crystal system. The rigid-core macromolecules of P3 are capable of aligning together with π-π stacks (columns) of board-like supramolecules C1.

The P3/C1=65/35 mol % composition was prepared as follows: 5.12 g (0.0065 mol) of cesium salt of P3 was dissolved in 475 g of de-ionized water (conductivity ˜5 μm/cm); the suspension was mixed with a magnet stirrer. After dissolution, the solution was filtered with the hydrophilic nylon filter with pore size 45 μm. Separately, 1.86 g (0.0035 mol) of C1 was dissolved in 60 g of de-ionized water; the suspension was mixed with a magnet stirrer. While stirring, 4.4 ml of 20 wt. % Cesium hydroxide (0.007 mol) was gradually added drop-by-drop into suspension for approximately 15 minutes until a clear solution was formed. Clear solutions of P3 and C1 were mixed together to form 547 g of a clear solution. This composition was concentrated on a rotary evaporator in order to remove an excess of water and form 127 g of a binary composition representing a lyotropic liquid crystal (LLC) solution. The total concentration of the composition (P3+C1) C_{TOT} was equal to about 6 wt. %.

The coatings were produced and optically characterized as described in the Example 14. The value of NZ-factor of the coatings is equal to about 2.4.

### Example 18

This Example describes preparation of a solid optical retardation layer of B_{A}-type from a solution of 4,4′-(5,5-dioxidodibenzo[b,d]thiene-3,7-diyl)dibenzenesulfonic acid (structure 29 in Table 4).

4,4′-(5,5-dioxidodibenzo[b,d]thiene-3,7-diyl)dibenzenesulfonic acid (1 g) was obtained as described in Example 12, mixed with 5.8 g of distilled water and 3.2 g of 20% aqueous solution of cesium hydroxide, and then stirred at room temperature (23° C.) for approximately 1 hour until a lyotropic liquid crystal solution was formed.

The coatings were produced and optically characterized as described in Example 14. The obtained retardation layer was characterized by the principle refractive indices, which obey the following condition: nₓ<n_{z}<n_{y}. NZ-factor at the wavelength λ=550 nm is about 0.4.

### Example 19

This Example describes the preparation of a solid optical retardation layer of B_{A}-type from a solution comprising a binary composition of the organic compounds P2 described in Example 16 and C1 described in Example 12.

The P2/C1=35/65 molar % composition was prepared as follows: 2.86 g (0.0035 mol) of the cesium salt of P2 was dissolved in 70 g of de-ionized water (conductivity ˜5 μm/cm); the suspension was mixed with a magnet stirrer. After dissolving, the solution was filtered at the hydrophilic nylon filter with pore size 45 μm. Separately, 3.44 g (0.0065 mol) of C1 was dissolved in 103 g of de-ionized water; suspension was mixed with a magnet stirrer. While stirring, 7.75 ml of 20 wt. % Cesium hydroxide was gradually added drop-by-drop into the suspension for approximately 15 minutes until a clear solution was formed. Clear solutions of P2 and C1 were mixed together to form 400 g of a clear solution. This composition was concentrated on a rotary evaporator in order to remove an excess of water and form 70 g of a binary composition representing a lyotropic liquid crystal (LLC) solution. The total concentration of composition (P2+C1) C_{TOT} was equal to about 11%.

The coatings were produced and optically characterized, as was described in Example 14, however, Gardner® wired stainless steel rod #4 was used instead of Gardner® wired stainless steel rod #8. The obtained solid optical retardation layer was characterized by principle refractive indices, which obey the following condition: nₓ<n_{z}<n_{y}. The NZ-factor at the wavelength λ=550 nm is equal to about 0.7.

Reference will now be made to the FIGURE in which the various elements of the present invention will be given numerical designations and in which the invention will be discussed so as to enable one skilled in the art to make and use the invention. It is to be understood that elements not specifically shown or described may take various forms well known to those skilled in the art.

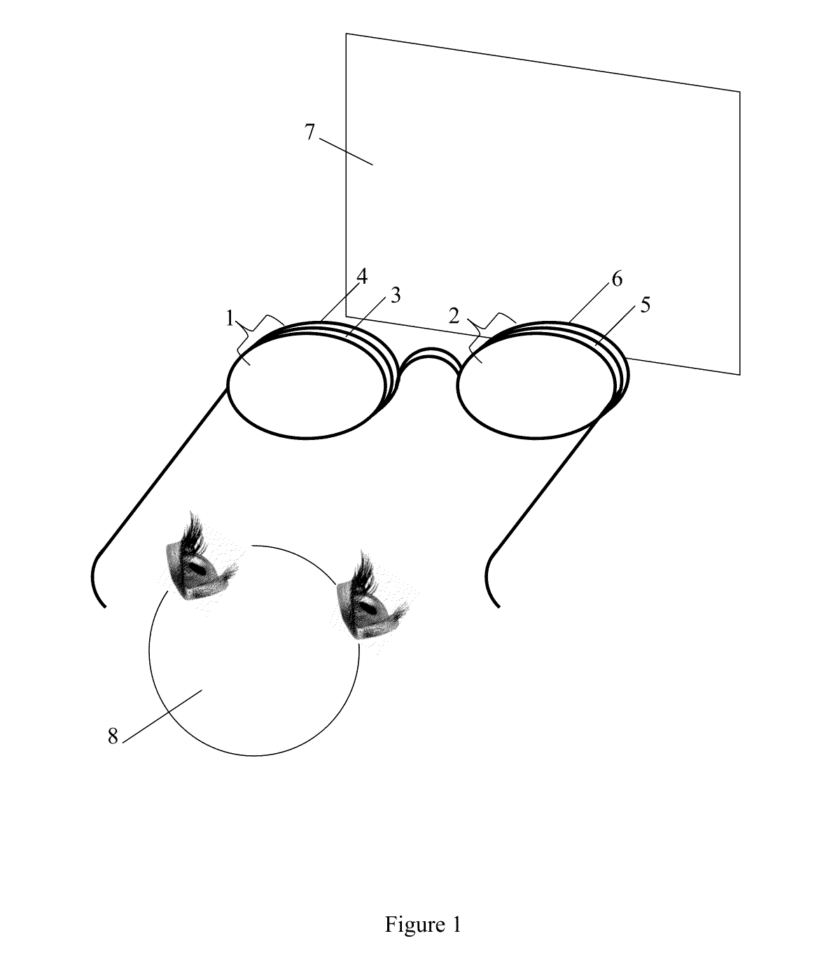

FIG. 1 schematically shows eyeglasses according to the present invention. The eyeglasses comprise a pair of orthogonal circular polarizing filters for left eye (1) and for right eye (2). The left eye filter comprises a linear polarizer (3) facing a viewer (8) and a retardation layer (4) located on the surface of the linear polarizer (3) and facing a 3D-image on the screen (7). The right eye filter comprises a linear polarizer (5) facing a viewer (8) and a retardation layer (6) located on the surface of the linear polarizer (5) and facing a 3D-image on the screen (7). The retardation layers are the solid optical retardation layers of B_{A}-type prepared according to Examples 18 or 19. The left circular polarizing filter possesses an in-plane retardation equal to λ₀/4, and the retardation layer of right circular polarizing filter possesses an in-plane retardation equal to 3λ₀/4, where λ₀ is a target wavelength in visible wavelengths range which equal to 500 nm.

Although the present invention has been described in detail with reference to a particular preferred embodiment, persons possessing ordinary skill in the art to which this invention pertains will appreciate that various modifications and enhancements may be made without departing from the spirit and scope of the claims that follow.

What is claimed is:

1. An eyeglasses comprising a pair of orthogonal circular polarizing filters wherein the circular polarizing filter comprises
a linear polarizer and
a retardation layer located on the surface of the linear polarizer,
wherein the retardation layer comprises
at least one organic compound of a first type, and/or
at least one organic compound of a second type,
wherein the organic compound of the first type has the general structural formula I 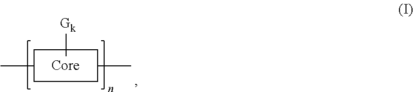
where Core is a conjugated organic unit capable to form a rigid-core macromolecule,
n is a number of the conjugated organic units in the rigid-core macromolecule, and
Gk is a set of ionogenic side-groups;
k is a number of the side-groups in the set Gk;
wherein the ionogenic side-groups and the number k provide solubility of the organic compound of the first type in a solvent and give rigidity to the rod-like macromolecule; the number n provides molecule anisotropy that promotes self-assembling of macromolecules in a solution of the organic compound or its salt,
wherein the number k is equal to 0, 1, 2, 3, 4, 5, 6, 7, or 8, and the number n is an integer in the range from 10 to 10000 and
wherein the organic compound of the second type has a general structural formula II 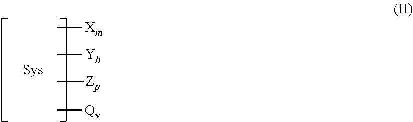
where Sys is an at least partially conjugated substantially planar polycyclic molecular system;
X, Y, Z, Q and R are substituents;
the substituent X is a carboxylic group —COOH, m is 0, 1, 2, 3 or 4;
the substituent Y is a sulfonic group —SO₃H, h is 0, 1, 2, 3 or 4;
the substituent Z is a carboxamide —CONH₂, p is 0, 1, 2, 3 or 4;
the substituent Q is a sulfonamide —SO₂NH₂, v is 0, 1, 2, 3 or 4;
wherein the organic compound of the second type is capable of forming board-like supramolecules via π-π-interaction, and the solid optical retardation layer is substantially transparent to electromagnetic radiation in the visible spectral range,
wherein the retardation layer of one circular polarizing filter possesses an in-plane retardation equal to λ₀/4 and the retardation layer of another circular polarizing filter possesses an in-plane retardation equal to 3λ₀/4, where λ₀ is a target wavelength in visible wavelength range.

2. An eyeglasses according to claim 1, wherein the type and degree of biaxiality of said optical retardation layer is controlled by a molar ratio of the organic compounds of the first and the second type in the composition.

3. An eyeglasses according to claim 1, wherein the type of retardation of said optical retardation layer is selected from the list comprising B_{A}-plate, positive A-plate, A_{C}-plate and negative A-plate.

4. An eyeglasses according to claim 1, wherein the central wavelength λ₀ is equal to 500 nm.

5. An eyeglasses according to claim 1, wherein the central wavelength λ₀ is equal to 550 nm.

6. An eyeglasses according to claim 1, wherein the rigid-core rod-like macromolecule has a polymeric main rigid-chain, and wherein the conjugated organic units are the same.

7. An eyeglasses according to claim 1, wherein the rigid-core macromolecule has a copolymeric main rigid-chain, and wherein at least one conjugated organic unit is different from others.

8. An eyeglasses according to claim 1, wherein at least one conjugated organic unit (Core) has the general structural formula III
-(Core1)-S1-(Core2)-S2- (III)
wherein Core1 and Core2 are conjugated organic components, and spacers S1 and S2 are selected from the list comprising —CO—NH—, —NH—CO—, —O—NH—, linear and branched (C₁-C₄)alkylenes, linear and branched (C₁-C₄)alkenylenes, —O—CH₂—, —CH₂—O—, —CH═CH—, —CH═CH—COO—, —OOC—CH═CH—, —CO—CH₂—, —OCO—O—, —OCO—, —C≡C—, —CO—S—, —S—, —S—CO—, —O—, —NH—, —N(CH₃)—, in such manner that oxygen atoms are not linked directly to one another.

9. An eyeglasses according to claim 1, wherein at least one rigid-core macromolecule is having the general structural formula IV
[-(Core1)-S1-(Core2)-S2-]ₙ₋ₜ[-(Core3)-S3-[(Core4)-s4-]ⱼ]ₜ (IV)
wherein Core1, Core2, Core3 and Core4 are conjugated organic components, spacers S1, S2, S3 and S4 are selected from the list comprising —CO—NH—, —NH—CO—, —O—NH—, linear and branched (C₁-C₄)alkylenes, linear and branched (C₁-C₄)alkenylenes, (C₂-C₂₀)polyethylene glycols, —O—CH₂—, —CH₂—O—, —CH═CH—, —CH═CH—COO—, —OOC—CH═CH—, —CO—CH₂—, —OCO—O—, —OCO—, —C≡C—, —CO—S—, —S—, —S—CO—, —O—, —NH—, —N(CH₃)—, in such manner that oxygen atoms are not linked directly to one another, n is an integer in the range from 10 to 10000, t is an integer in the range from 1 to n−1 and j is 0 or 1, and wherein at list one conjugated organic component out of Core3 and Core4 differs from Core1 and Core2.

10. An eyeglasses according to any of claim 8 or 9, wherein the conjugated organic components Core1, Core2, Core3 and Core4 comprising ionogenic groups G are selected from the structures having general formula 1 to 2: 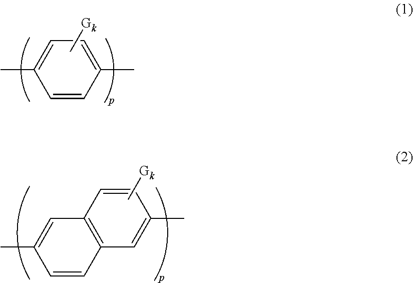
wherein the ionogenic side-groups G are selected from the list comprising —COOH, —SO₃H, and —H₂PO₃, k is equal 0, 1 or 2, p is equal to 1, 2 or 3.

11. An eyeglasses according to claim 1, wherein the organic compound of the first type is selected from structures 3 to 13, wherein the ionogenic side-group G is sulfonic group —SO₃H, and k is equal to 0, 1 or 2:

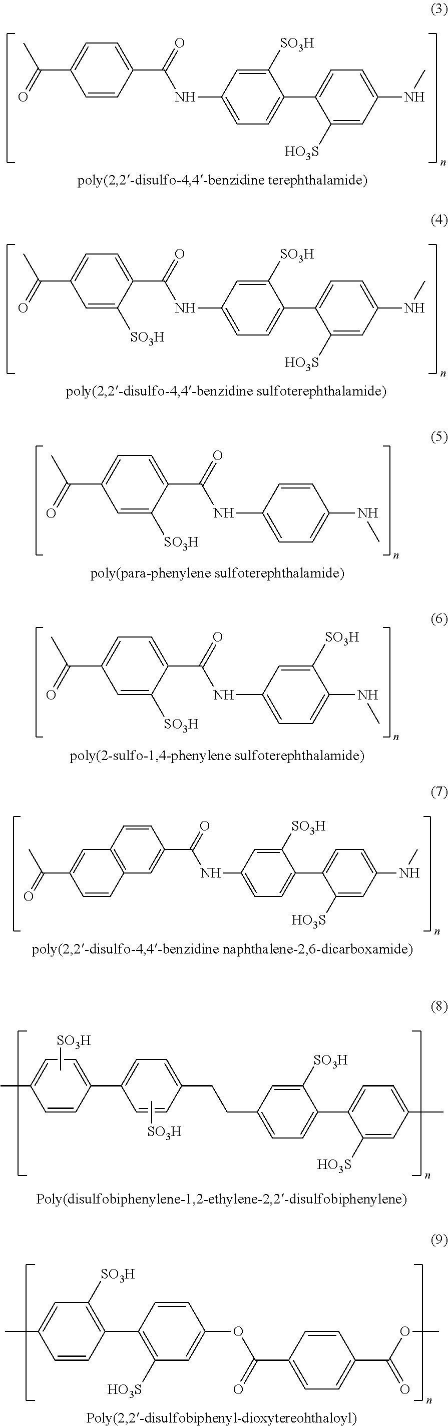

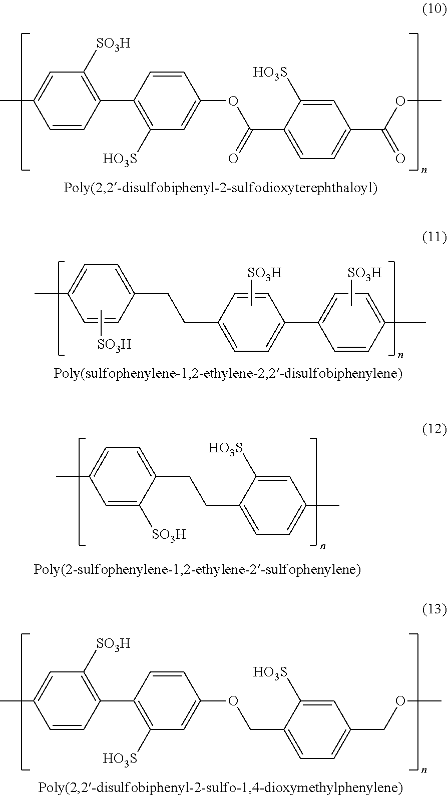

12. An eyeglasses according to claim 1, wherein the organic compound of the first type further comprises additional side-groups independently selected from the list comprising linear and branched (C₁-C₂₀)alkyl, (C₂-C₂₀)alkenyl, and (C₂-C₂₀)alkinyl.

13. An eyeglasses according to claim 12, wherein at least one of the additional side-groups is connected with the Core via a bridging group A selected from the list comprising —C(O)—, —C(O)O—, —C(O)—NH—, —(SO₂)NH—, —O—, —CH₂O—, —NH—, >N—, and any combination thereof.

14. An eyeglasses according to claim 1, wherein the salt of the organic compound of the first type is selected from the list comprising ammonium and alkali-metal salts.

15. An eyeglasses according to claim 1, wherein the organic compound of the second type has at least partially conjugated substantially planar polycyclic molecular system Sys selected from the structures of general formulas 14 to 28:

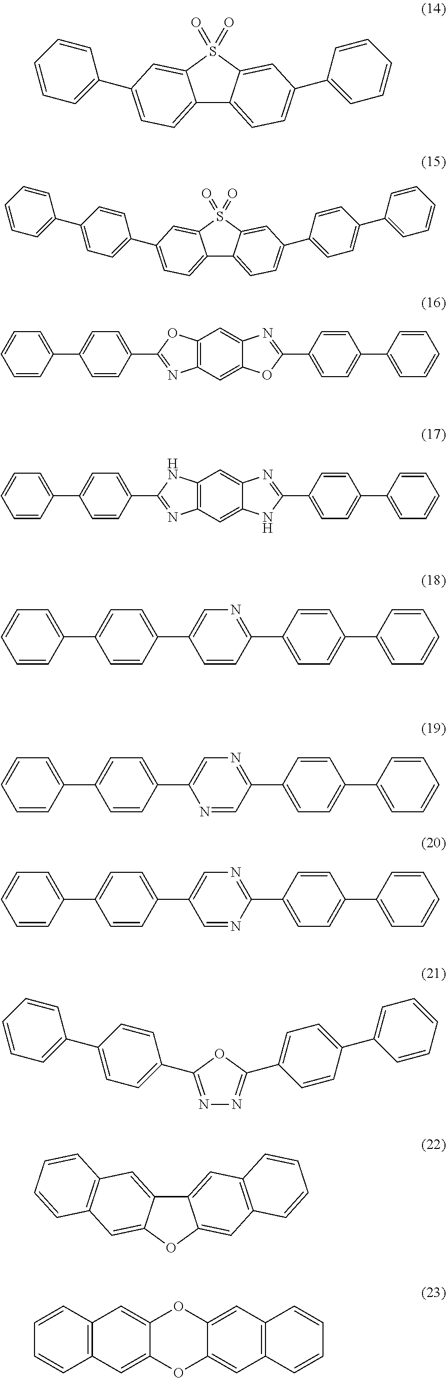

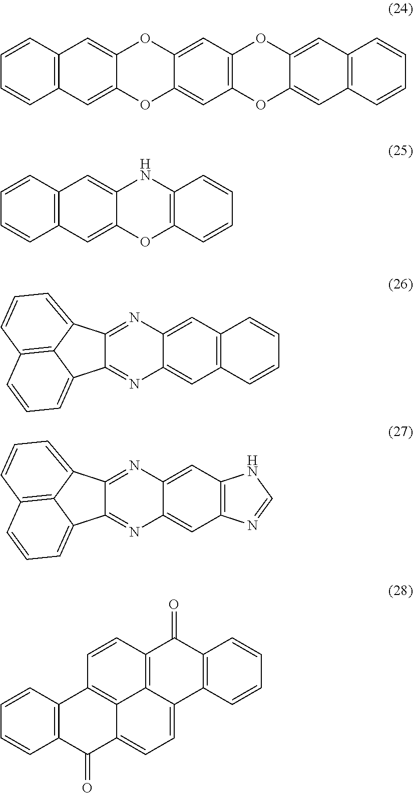

16. An eyeglasses according to claim 15, wherein the organic compound of the second type is selected from structures 29 to 37, where the molecular system Sys is selected from the structures 14 and 22 to 28, the substituent is a sulfonic group —SO₃H, and m, p, v, and w are equal to 0:

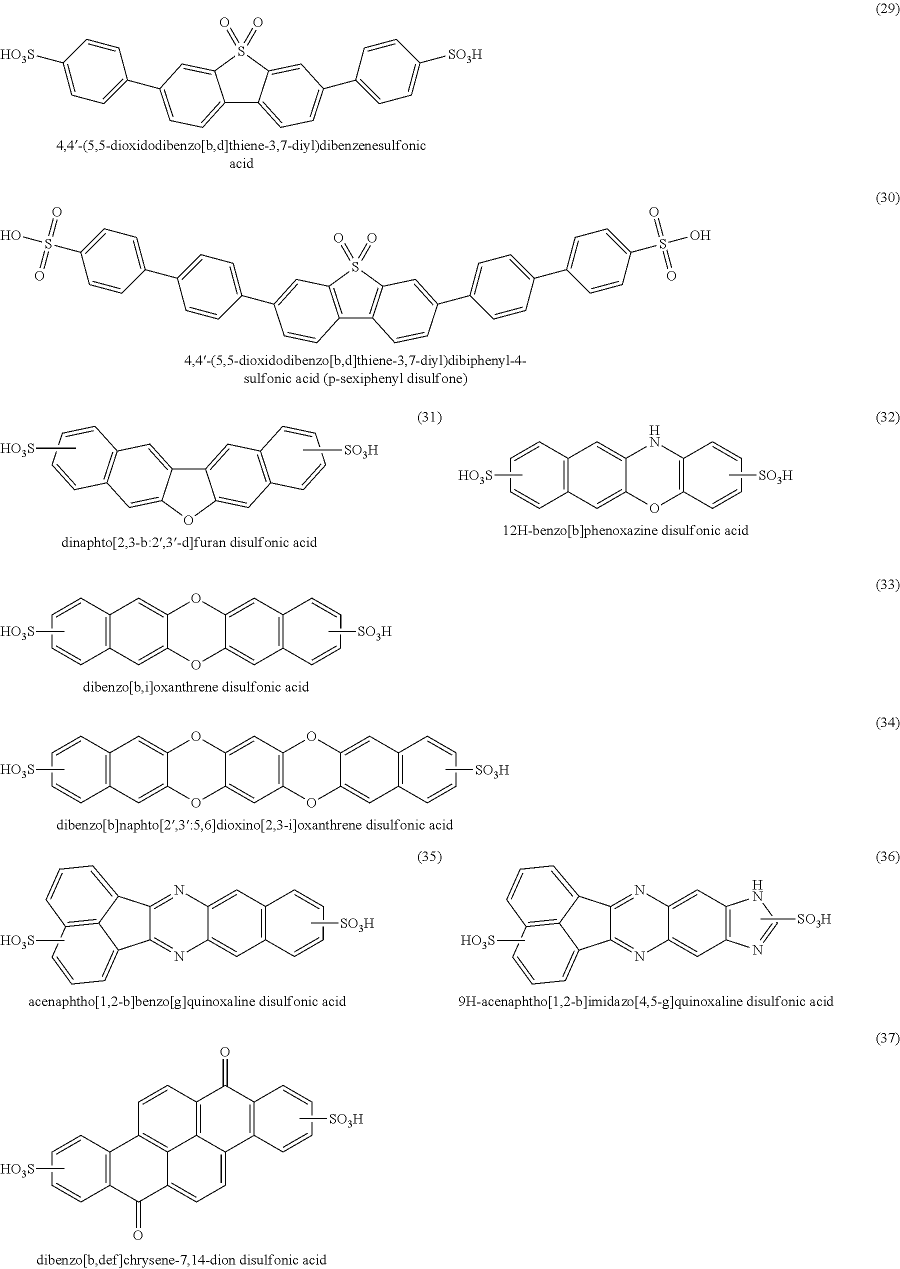

17. An eyeglasses according to claim 1, further comprising inorganic compounds which are selected from the list comprising hydroxides and salts of alkali metals.

18. An eyeglasses according to claim 1, wherein the linear polarizer is made on a substrate of a birefringent material, which is selected from the list comprising polyethylene terephtalate (PET), polyethylene naphtalate (PEN), polyvinyl chloride (PVC), polycarbonate (PC), polypropylene (PP), polyethylene (PE), polyimide (PI), and polyester.
